(19) United States
(12) Patent Application Publication
(10) Pub. No.: US 2010/0049417 A1
(43) Pub. Date: Feb. 25, 2010

(54) Dual ECU for aftermarket conversions of vehicles and boats to oxy-hydrogen or hybrid fuels

(75) Inventors: Kenneth Stephen Bailey, San Jose, CA (US); Gary Bethurem, Simi Valley, CA (US)

Correspondence Address: Kenneth Bailey;Unit 12-A, 95 Hobson Street, San Jose, CA, 95110, US

(73) Assignee: Advanced Combustion Tecnology, Chatsworth, CA (US)

(21) Appl. No.: 12/583,181

(22) Filed: Aug. 15, 2009

Related U.S. Application Data
(60) Provisional application No. 61/092,728, filed on Aug. 28, 2008.

(51) Int. Cl. F02C 9/26; F02D 41/00; F02B 43/00; F02C 7/22; C25B 1/06

(52) U.S. Cl. 701/100; 701/101; 123/3; 60/39.12; 205/632

(57) ABSTRACT

Modern ECU's control fuel flow and efficiency of high performance vehicles. Converting a standard fossil fuel vehicle or boat to oxy-hydrogen requires monitoring of additional factors such as oxy-hydrogen burn rates, oxy-hydrogen flow, oxy-hydrogen temperature, oxy-hydrogen production rates and overall factors such as barometric pressure, altitude, humidity, ambient temperatures etc. When a vehicle operating as a hybrid, experiences difficulties with oxy-hydrogen production, burn rate, fuel flow, or operating temperature, the ECU must compensate and revert back to fossil fuel operating status, or suffer engine failure and potentially costly mechanical damages.

The herein described invention compensates for the combined mixture of oxy-hydrogen and fossil fuels to give a highly fuel efficient clean burning engine under normal operations, and automatically reverts back to fossil fuel parameter ECU mapping, if the oxy-hydrogen system should fail to deliver the required volume of oxy-hydrogen gas, or various types of hybrid fuels are used from time to time to increase fuel efficiency, and reduce costs, the herein described dual ECU system will thereby allow the vehicle to continue to operate normally, under all types of conditions, climates, temperature changes or changes in altitude.

### BACKGROUND OF THE INVENTION

1. Field of the Invention

This invention relates generally to the automotive computer system found on all newly manufactured motor vehicles including trucks, automobiles, motorcycles, and boats. The Electronic Control Unit (ECU) controls the mixture ratio of fuel (typically gasoline or kerosene) and oxygen at the fuel injectors or carburetor, as is present at the time of combustion in the cylinder chamber of the engine, and adjusts the engine ignition timing accordingly, to prevent Knock.

2. Background of the prior art

The ratio of gasoline to oxygen at the time of ignition is called the stoichiometeric mixture. This stoichiometric mixture is ideally set to a ratio of 14.7 to 1. The ECU accomplishes this by monitoring several key elements, fundamental to all combustion engines, i.e. exhaust gas temperature, exhaust oxygen levels, throttle position, rpm's, torque, power requirements, engine temperature, manifold absolute pressure (MAP), outside air temperature and humidity, as well as other factors. The computer (ECU) listens for engine Knock, and adjusts the engine ignition timing according to a precise set of numbers loaded into a look-up table within the ECU, designed by the manufacturer of the vehicle.

A hybrid digital design was popular in the mid 1980s. This used analogue techniques to measure and process input parameters from the engine, then used a look-up table stored in a digital ROM chip to yield pre-computed output values. Later systems compute these outputs dynamically. The ROM type of system is amenable to tuning if one knows the system well. The disadvantage of such systems is that the pre-computed values are only optimal for an ideal, new engine. As the engine wears, the system is less able to compensate than a CPU based system. Additionally, programmable ECUs are required where significant aftermarket modifications have been made to a vehicle's engine. Examples include, adding or changing of a turbocharger, adding or changing of an intercooler, changing of the exhaust system, and conversion to run on alternative fuels, or hydrogen gas.

Modem ECUs use a microprocessor which can process the inputs from the engine sensors in real time. The electronic control unit contains the hardware and firmware. The hardware consists of electronic components on a printed circuit board, ceramic substrate or a thin laminate substrate. The main component on this circuit board is a microcontroller chip (MCU). The software is stored in the microcontroller or other chips on the printed circuit board, typically in EPROMs or flash memory so the CPU can be re-programmed by uploading updated code or replacing chips. This is also referred to as an electronic Engine Management System (EMS).

Sophisticated engine management systems receive inputs from other sources, and control other parts of the engine; for instance, some variable valve timing systems are electronically controlled, and turbocharger wastegates are also controlled and managed. They also may communicate with transmission control units or directly interface electronically-controlled automatic transmissions, traction control systems, etc. The Controller Area Network or CAN bus automotive network is often used to achieve communication between these devices.

Modem ECUs sometimes include features as cruise control, transmission control, anti-skid brake control, and anti-theft control, etc.

General Motors' first ECUs had a small application of hybrid digital ECUs as a pilot program in 1979, but by 1980, all active programs were using microprocessor based systems. Due to the large ramp up of volume of ECUs that were produced to meet the US Clean Air Act requirements for 1981, only one ECU model could be built for the 1981 model year. The high volume ECU that was installed in GM vehicles from the first high volume year, 1981, onward was a modem microprocessor based system. GM moved rapidly to replace carburetor based systems to fuel injection type systems starting in 1980/1981 Cadillac engines, following in 1982 with the Pontiac 2.5L “GM Iron Duke engine” and the Corvette Chevrolet Small-Block “Cross-Fire” engine. In just a few years all GM carburetor based engines had been replaced by throttle body injection (TBI) or intake manifold injection systems of various types. In 1988 Delco Electronics, Subsidiary of GM Hughes Electronics, produced more than 28,000 ECUs per day, the world's largest producer of on-board digital control computers at the time.

As usually occurs with a technology shift, computer-controlled engine management has replaced old failure modes with new ones. With advanced age, a failing ECU can cause seemingly random starting and drive ability faults. For example, a vehicle may refuse to start when cranked with the starter motor, but may respond easily to a push start. Failing electrolytic capacitors in the ECU no longer smooth the power supply to the microprocessor, and the varying load on the starter motor causes sufficient line voltage fluctuation that the computer reboots repeatedly while attempting to start the engine. An industry has evolved to refurbish ECUs with this and other types of failures related to age and use.

Similarly, all types of boats, motorcycles, lawnmowers and even power tools come equipped with varying forms of ECU's.

In modern high performance engines and racing cars, the ECU is frequently and customarily remapped both during races (as is the case in racing vehicles), and as road conditions, climate, humidity, and types of fuels being burned all change from time to time.

Currently, the most common types of alternative fuel other than raw gasoline and kerosene are: Cellulosic Ethanol (CE), Algal Biodiesel (AB), Biobutanol (BB), Green Gasoline (GG), Designer Hydrocarbons (DH), Fourth-Gen Fuels (FGF). The respective energy yields by type are: CE—66%, AB—103%, BB—90%, GG—100%, DH—106%, FGF—103%, which makes all of these alternative fuels very attractive to consumers.

As oxy-hydrogen burning vehicles are relatively new to the scene, a whole new set of rules apply in terms of fuel management, oxygen sensors, engine exhaust gas temperatures, and throttle position. In addition to the normal parameters monitored and controlled by the manufacturer's ECU, after market vehicles need to measure, monitor and compensate for changes that may occur in the oxy-hydrogen portion of the fuel production and delivery system incorporated within the vehicle. These added parameters include such things as the fuel (oxy-hydrogen) temperature, rate of flow, mixture ratio with fossil fuels, quality of gases, method of injection into the carburetor system, and driving conditions, such as outside temperature, humidity, altitude, type of engine (gasoline or diesel), and type of roadway (i.e. graded or flat).

In standard fossil fueled vehicles for example, the ideal air fuel ratio (in gasoline engines) is expected to be around 14.7 to 1. Keeping the air-fuel mixture near the stoichometric ratio of 14.7:1 (for gasoline engines) allows the catalytic converter to operate at maximum efficiency.

An air-fuel mixture leaner than the stoichometric ratio will result in near optimum fuel mileage, costing less per mile traveled and producing the least amount of CO² emissions. However, at the factory, cars are designed to operate at the stoichometric ratio (rather than as lean as possible) in order to maximize the efficiency and life of the catalytic converter. While it may be possible to run smoothly at mixtures leaner than the stoichimetric ratio, manufacturers must focus on emissions and especially catalytic converter life (which must now be 100,000 miles on new vehicles) as a higher priority, due to U.S. Environmental Protection Agency regulations.

Carefully mapping out air-fuel ratios throughout the range of rpm and manifold pressure will maximize power output in addition to reducing the risk of detonation (Knock).

Lean mixtures improve the fuel economy but also cause sharp rises in the amount of nitrogen oxides (NOX). If the mixture becomes too lean, the engine may fail to ignite, causing misfire and a large increase in unburned hydrocarbon (HC) emissions. Lean mixtures burn hotter and may cause rough idle, hard starting and stalling, and can even damage the catalytic converter, or burn valves in the engine. The risk of spark knock/engine knocking (detonation) is also increased when the engine is under load.

Mixtures that are richer than stoichometric allow for greater peak engine power when using gaseous fuels, due to the cooling effect of the evaporating fuel. This increases the intake oxygen density, allowing for more fuel to be combusted and more power developed. The ideal mixture in this type of operation depends on the individual engine. For example, engines using forms of forced induction such as turbochargers and superchargers typically require a richer mixture under wide open throttle than naturally aspirated engines.

Cold engines also typically require more fuel and a richer mixture when first started, because fuel does not vaporize as well when cold and therefore requires more fuel to properly “saturate” the air. Rich mixtures also burn slower and decrease the risk of spark knock/engine knocking (detonation) when the engine is under load. However, rich mixtures sharply increase carbon monoxide (CO) emissions, which is bad for the environment.

Oxygen sensors are installed in the exhaust system of the vehicle, attached to the engine's exhaust manifold, the sensor measures the ratio of the air-fuel mixture. There are two types of sensors available; narrow band and wide band. Narrow band sensors were the first to be introduced. The wide band sensor was introduced much later.

A narrow band sensor has a non-linear output, and switches between the thresholds of lean (ca 100-200 mV) and rich (ca 650-800 mV) areas very steeply. Also, narrow band sensors are temperature-dependent. If the exhaust gases become warmer, the output voltage in the lean area will rise, and in the rich area it will be lowered. Consequently, a sensor, without pre-heating has a lower lean-output and a higher rich-output, possibly even exceeding 1 Volt. The influence of temperature to voltage is smaller in the lean mode than in the rich mode.

A “cold” engine makes the sensor switch the output voltage between ca 100 and 850/900 mV and after while, the sensor may output a switch voltage between ca 200 and 700/750 mV, and in the case of turbocharged cars even less.

The Engine Control Unit (ECU) tries to maintain a stoichiometric balance, wherein the air-fuel mixture is approximately 14.7 times the mass of air to fuel for gasoline. This ratio is selected in order to maintain a neutral engine performance (lower fuel consumption yet decent engine power and minimal pollution).

The average level of the sensor is defined as 450 mV. Since narrow band sensors cannot output a fixed voltage level between the lean and the rich areas, the ECU tries to control the engine by controlling the mixture between lean and rich in such a sufficiently fast manner, that the average level becomes ca 450 mV. A wide band sensor, on the other hand, has a very linear output, 0-5 V, and is not temperature dependent.

Hydrogen as a prime alternative fuel for motor vehicles got a big push, when in 2003, President Bush announced the $1.2 billion Hydrogen Fuel Initiative. All of a sudden, fuel cells were the talk of the alternative fuel world. Startups blossomed, research monies flowed, and it was like a dot-com bubble, that never burst. Public interest has faded since then, but research has continued toward commercialization. In January of 2008, Ballard Power, the company that pioneered the use of hydrogen as a replacement for fossil fuels to power modern vehicles was sold to Daimler and Ford.

In June of 2008 Honda introduced the first fuel cell powered automobile, the FCX Clarity, which boasts 280 miles on a tank of hydrogen gas, and the efficiency equivalent to 74 miles per gallon, in a four passenger sedan vehicle. Toyota's fuel-cell electric hybrid with a range of 500 miles will be available in late 2008, in Japan.

The Honda Corporation has now introduced the Home Hydrogen Fueling Station. This home unit produces a gas that is 40% to 50% hydrogen gas. A membrane filters out pure hydrogen gas, which is then compressed for fuel. There's no storage tank, so one's car slow-fills from the pump at night. It takes about six (6) hours to reach maximum capacity of 171 liters of hydrogen gas at 5,000 psi. It actually produces 50 standard liters of gas per minute.

The various parameters required of the ECU change drastically with the use of Hydrogen or Oxy-Hydrogen gases as an alternative fuel replacement. While with fossil fuels, the stoichiometric mixture is set at around 14.7 to 1 optimally, in the case of hydrogen as a fuel, the stoichiometric mixture needs to be adjusted to around 30 to 1. This drastic shift requires an entirely new set of parameters be loaded into the ECU ROM in order to achieve maximum engine performance, in fact without a new ECU, the average vehicle today would not be able to run on alternative fuels, let alone pure hydrogen gases, without the herein described modifications to the on onboard ECU. It is the intention of the present invention to solve this problem, so that current after market vehicles of all types can use these alternatives fuels immediately, as well.

### SUMMARY OF THE INVENTION

It is the intention of the present invention to teach a means for after market motor vehicles of all types to benefit from the various types of alternative or biofuels being offered today as well as hydrogen fuels and oxy-hydrogen fuels. Last year (2007) Americans consumed more than 142 billion gallons of gasoline at the rate of 16 million gallons per hour. At the same time, these vehicles produced 20 pounds of CO2 per gallon. Alternatives such as biofuels, electric cars, and hydrogen are finally catching up, and gaining favor as potential long term solutions.

In the present invention, the ECU must compensate for alternative fuels, but at the same time be able to run on plain old gasoline or kerosene. If the hydrogen fuel cell fails to produce enough hydrogen, or the hydrogen gas generator fails all together, the engine must be able to revert back to standard fossil fuels on a moments notice. By merely reloading the lookup table to the ECU, there will be a lot of motorists who have had their present vehicles converted to alternative fuels, stranded at the side of the road, unable to start their engines because the ECU parameters need to be changed to compensate for the changed fuel flow requirements or other outside factors.

The present invention solves this problem by creating a new set of rules for the alternative ECU lookup table, and adding additional transducers to measure needed parameters to compensate and adjust for changing conditions, and different types of fuel, while at the same time maintaining the old parameters which will allow the engine to revert to standard fossil fuel if and when needed to compensate for catastrophic failure of the oxy-hydrogen fuel cell, or lack of available bio-fuels at the time.

To the standard ECU, we have added a number of features with their own set of sensors to help in tuning the engine for optimal performance while on the road. On the hydrogen fuel source we have added a temperature transducer, a pressure transducer, a flow meter transducer, a gas cooling unit, a gas heating unit, and an enhanced O2/CO2 sensor. Under the hood we have added a kill switch to revert back to the standard ECU ROM lookup tables, and disable the Oxy-Hydrogen gas generator if necessary. We have created a water storage chamber that is coated with graphite to reduce the production of unwanted lye build up, to enhance and extend the useful life of the hydrogen gas generator.

### BRIEF DESCRIPTION OF THE DRAWINGS

FIG. 1 depicts the standard ECU found on most types of modern vehicles.

FIG. 2 depicts the improved ECU which is subject of this patent. Added sensors include but are not limited to: Oxy-Hydrogen water temperature, Oxy-hydrogen gas temperature, Oxy-Hydrogen gas manifold pressure, Carbon Dioxide levels of emissions while driving, an improved Oxygen sensor, Oxy-Hydrogen gas flow control, Oxy-Hydrogen gas On/Off control, Altitude sensor, Oxy-Hydrogen cooling tube etc.

FIG. 3 depicts the calculations of the ratio of Oxy-Hydrogen gas and nitrogen/air that is required for ideal combustion in a stoichiometric mixture in a fuel injected or carbureted vehicle's intake manifold system.

FIG. 4 depicts the comparison of fuel usage and efficiency of gasoline versus Oxy-Hydrogen gas being used to fuel a combustion engine vehicle.

FIG. 5 depicts the Oxy-Hydrogen system as might be deployed in a vehicle or boat utilizing the herein described technologies.

FIG. 6 depicts the detailed drawing of the cooling system used in the present invention to cool the Oxy-Hydrogen at the injection point to achieve great overall efficiency and horse power.

FIG. 7 depicts the intake manifold showing the herein described sensors as well as the exhaust manifold and tailpipe. The improved Oxy-Hydrogen O2 and CO2 sensor is displayed in an expanded view, as might be deployed in the exhaust manifold system of the vehicle.

FIG. 8 depicts the schematic circuit diagram of the CO2/O2 Thermopile sensor.

FIG. 9 depicts the schematic diagram of the temperature dependent Thermopile CO2/O2 sensor as might be deployed in the present invention.

FIG. 10 depicts the basic flow chart example of the operation of the present invention in normal application in the control of the various elements of the engine to insure optimal performance.

### DETAILED DESCRIPTION OF THE DRAWINGS

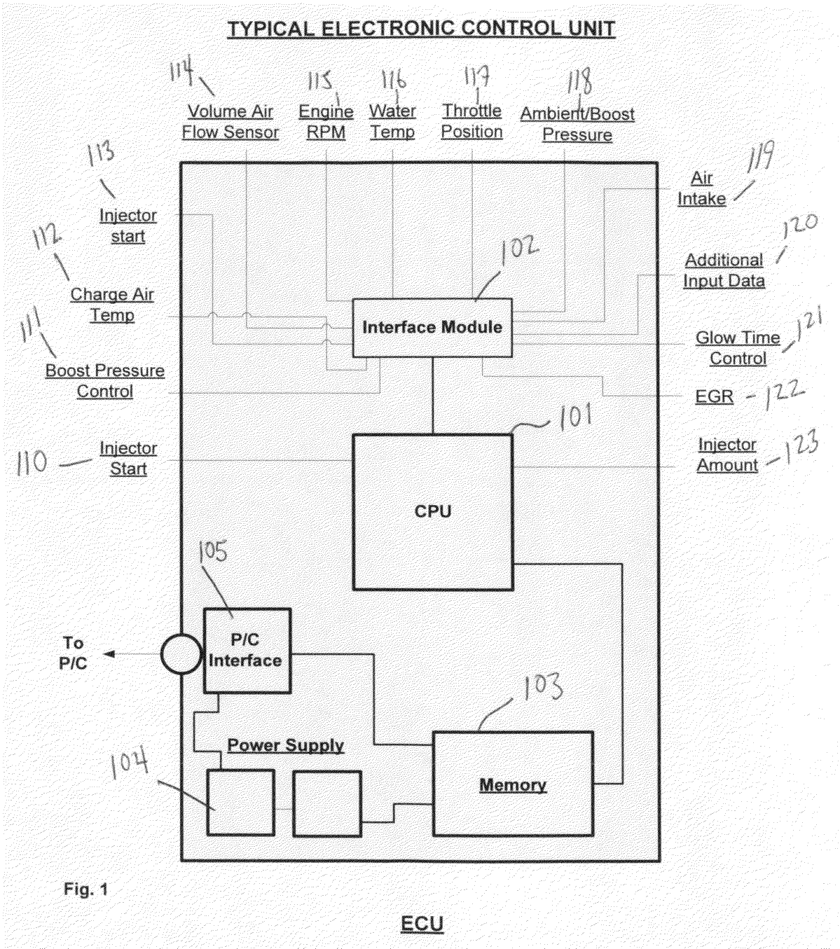

FIG. 1 depicts a typical ECU that might be found in most modern cars or trucks today. The standard ECU comprises a CPU (101), an Interface Module (102), a Memory Chip (103), a power supply (104), and a P/C Interface (104). Together these components act to monitor and control the Injector Start (110), the Boost Pressure Control (111), the Charge Air Temperature (112), the secondary Injector Start (113), the Volume Airflow Sensor (114), the Engine RPM (115), the Water Temperature (116), the Throttle Position (117), the Ambient Boost Pressure (118), the Air Intake (119), the Additional Input Data from the LCD Control Module (120), the Glow Time Control (121) (as found in diesel powered vehicles such as tractor-trailer trucks), the EGR (122), and the Injector Amount (123), for example.

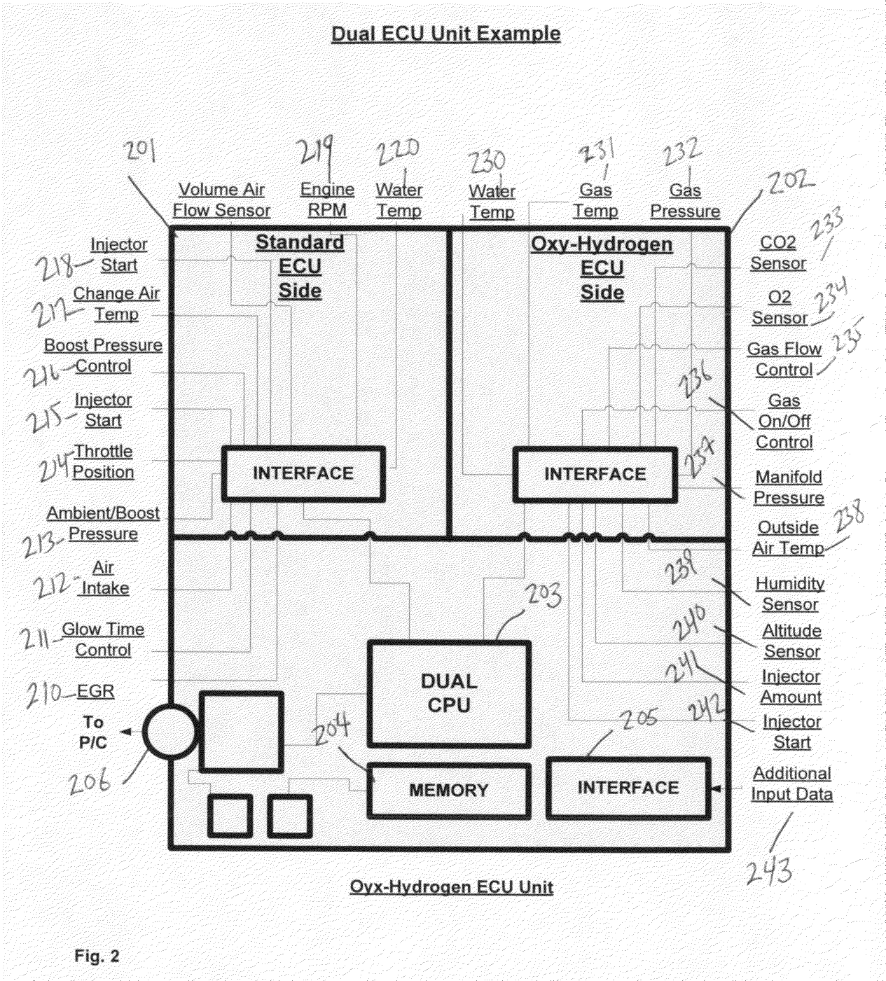

FIG. 2 depicts the components intended to be included in the present invention and are more particularly described throughout the specifications herein as follows. A Dual ECU System comprising, a Standard ECU with Interface (201), and a HHO ECU with Interface (202). Both the Standard and HHO ECU's as disclosed herein share a common CPU (203), a common Memory (204), a common Interface (205), and a common P/C Interface (206). This Dual ECU combination both monitors and controls such things as the EGR (210), the Glow Time Control (211) (as is found in diesel powered vehicles commonly used), the Air Intake Monitor (212), the Ambient Boost Pressure Monitor (213), the Throttle Position (214), the Injector Start (215), the Boost Pressure Control (216), the Change Air Temperature (217), the Volume Airflow Sensor (218), the Engine RPM Sensor (219), and the Engine Water Temperature (220), on the Standard ECU side (201). On the HHO Interface side (202) we teach a H20+KOH Water Temperature Sensor (230), a H2 gas Temperature Sensor (231), an H2 gas Pressure Sensor (232), a CO2 Sensor (233), an O2 Sensor (234), a Gas Flow Control (235), a H2 gas On and Off Control Interface (236), a Manifold Pressure Sensor (237), an Outside Temperature Sensor (238), a Humidity Sensor (239), an Altitude Sensor (240), an Injector Volume Amount Sensor (241), an Injector Start Sensor (242), and an Additional Input Data Interface (243).

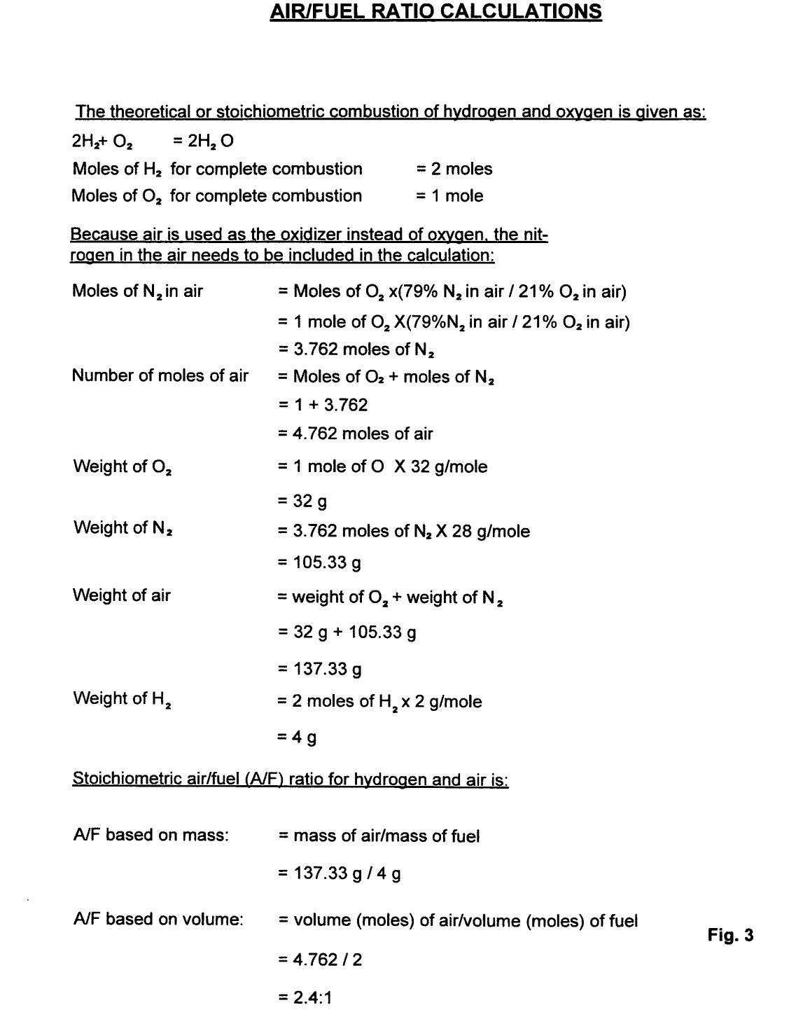

FIG. 3 teaches the calculation (in mathematical terms) of the preferred ratios of combustible gases (HHO) and Oxygen to provide clean and efficient pollution free combustion is illustrated, calculated and determined.

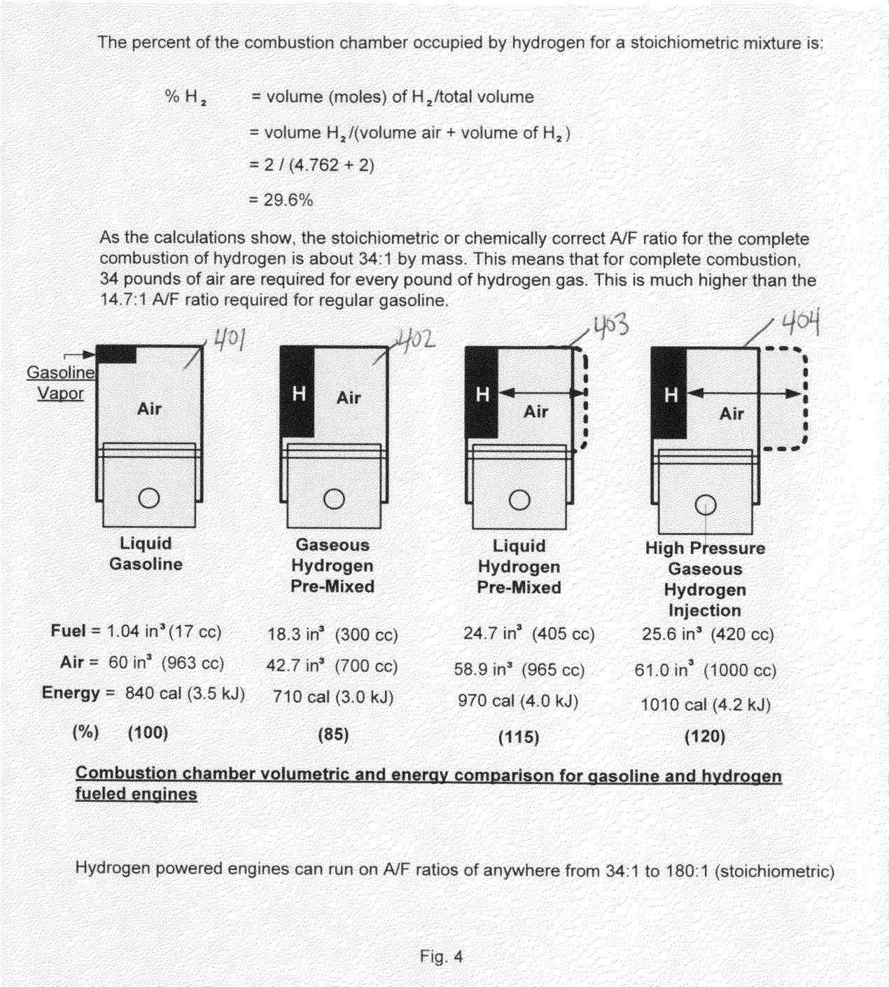

FIG. 4 depicts the combustion chamber of four typical piston engines and the fuel to air ratios (for example) that produce the best overall horse power and consumes the least amounts of fuels in so doing. In cylinder (401) the enriched mixture of Gasoline and Oxygen combine to produce about 840 Cal (3.5 k joules) of Energy. This example is given the standard weighted average of 100% power as is found in most standard unmodified vehicles in use today. In cylinder example (402) the combustible mixture consists of H2 and Oxygen and that combination actually results in less horse power 710 cal (3.0 k joules of Energy. In cylinder 3 example (403), we take liquid H2 with Oxygen and if the necessary volume of air were there, we would get greater horse power by 15% above standard gasoline and oxygen mixture as in example (401). In example (404), we take High Pressure H2 combined with Oxygen, and if we could get 50% more air in the chamber we would then derive about 20% greater horse power. These several examples prove the need for a Dual ECU system as is described in detail herein, since the use of H2 or HHO to power a vehicle without additional air in the mixture (as opposed to a standard ratio of 14.7:1) will result in decreased performance and reduced horse power by at least 15% overall. By controlling the amount of air present in the combustion chamber we can increase the mixture to a ratio of around 34:1 thereby increasing horse power and reducing emissions.

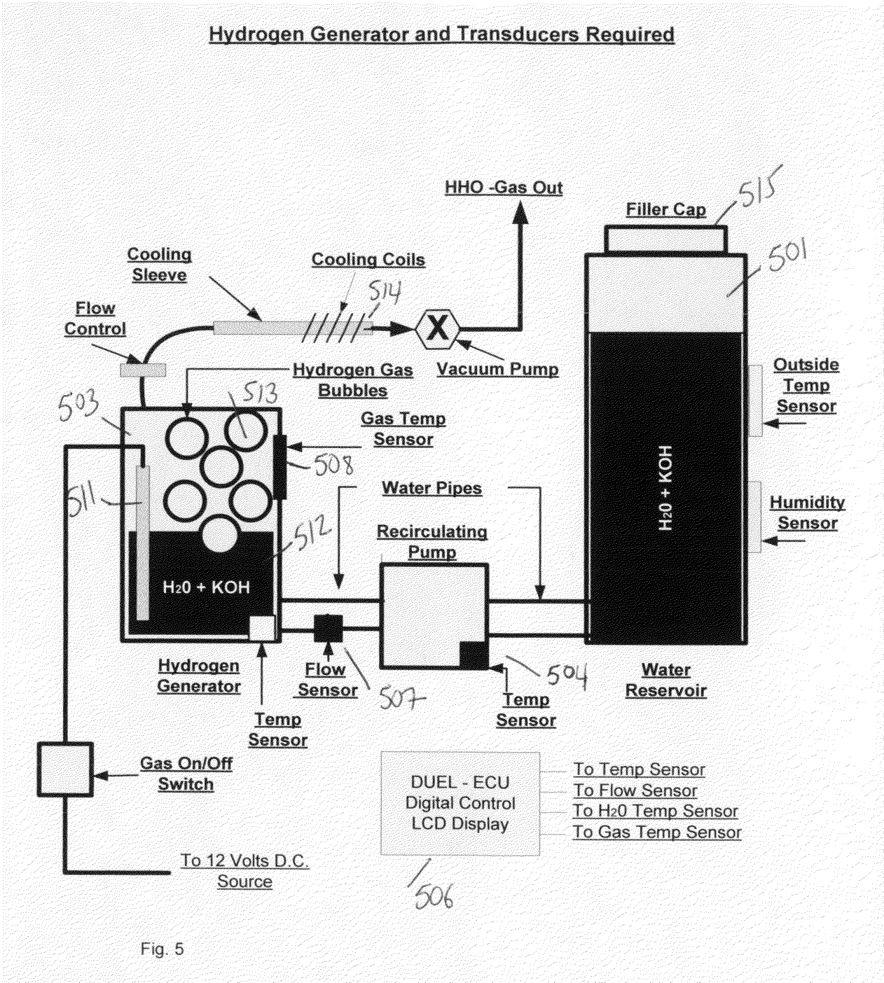

FIG. 5 depicts the HHO gas generator example and the additional sensors that are needed in order to properly control the amount of HHO gas generated and the transducers that are connected to the Dual ECU to control the mixture. In the preferred embodiment the HHO gas generator has a H2O+KOH liquid storage tank (501). This storage tank (501) is connected to plastic water pipes that re-circulate the mixture through a recirculation pump (502), that is connected to the HHO Generator (503). The re-circulating pump has a temperature sensor (504) that is connected to the Digital Control and Output readings are displayed on the LCD Display (506). The Digital Control and LCD Display (506) are also connected to the Liquid Flow Sensor (507), the H2O+KOH Temperature Sensor (508), and the HHO Gas Temperature Sensor (509). The ON/OFF Switch (510) is controlled by the Dual ECU referred to herein above and in FIG. 2 by reference herein. The HHO Generator (508) has Stainless Steel Electrolytic Plates (511) that are submerged in the H2O+KOH Solution (512) which are powered by a 12 Volt D.C. Source. Once the HHO Manufactured Gases (513) leave the HHO Generator (508), the gasses are then cooled to the desired temperature for combustion by the Cooling Coils (514) which then outputs the HHO cooled gasses to the combustion engine or turbine engine. The H2O+KOH Water Reservoir (501) has a tight fitting Filler Cap (515) with a vent hole inside.

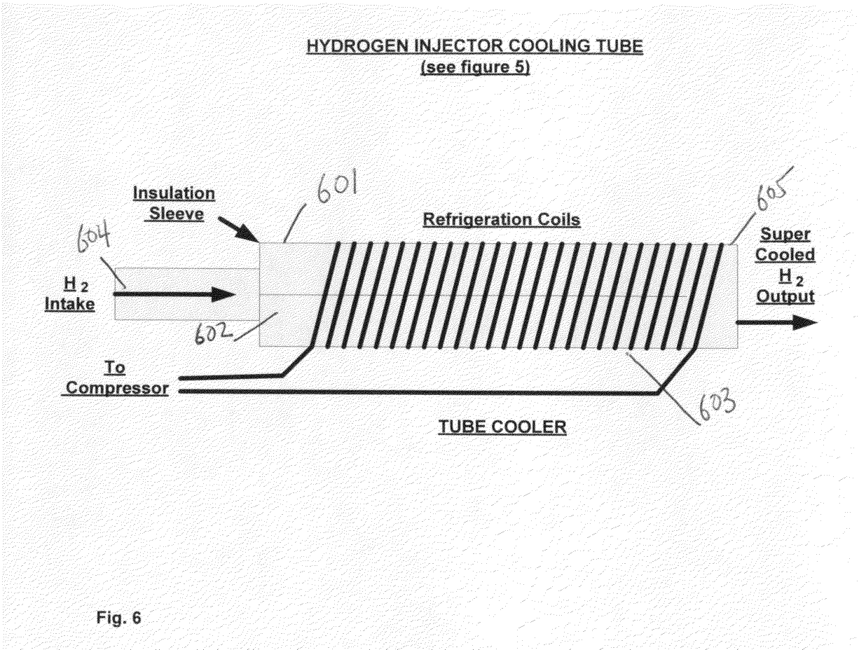

FIG. 6 depicts the Tube Cooler (601) which comprises a Insulation Sleeve (602), a series of Refrigeration Coils (603), an H2 Intake Port (604), an H2 Super Cooled Output Port (605), and the Refrigeration Coils are connected to a Freon Type Compressor. This Super Cooling of the H2 Gasses creates a hotter and more fuel efficient explosion in the Combustion Chamber which increases horse power and reduces Greenhouse Emissions entirely.

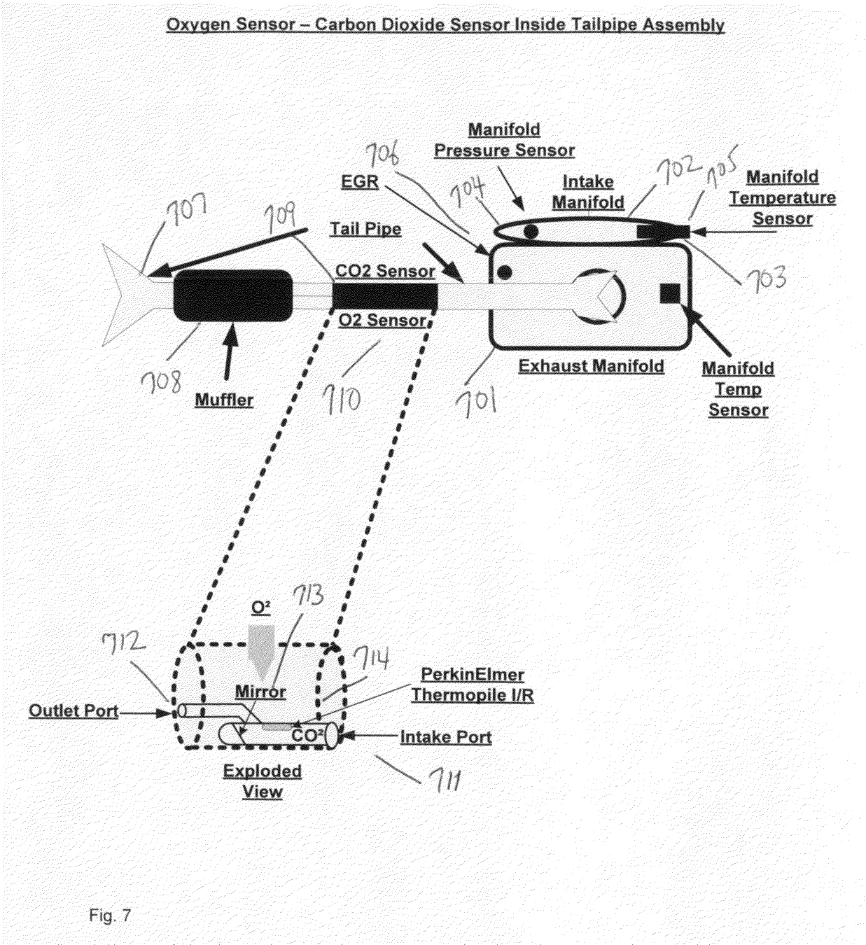

FIG. 7 depicts the Exhaust Manifold (701), comprising an Intake (702) with a Temperature Sensor (703) which is monitored by the MPU in the Dual ECU as described in FIG. 2 incorporated herein by reference thereto. The Intake Manifold (702) has a Manifold Pressure Sensor (704), and a Manifold Temperature Sensor (705). The Exhaust Manifold (701) also has a EGR Sensor (706). The Exhaust Manifold (701) is connect to the Tail Pipe Assembly (707), which comprises a Muffler (708), a CO2 Sensor (709), and a O2 Sensor (710). Inside the Tail Pipe Sensors Assembly as is depicted in the exploded view, there is an Intake Port (711), and Outlet Port (712), a Mirror (713), and a Perkin Elmer type Thermopile I/R Sensor (714). These various sensors that are depicted in FIG. 7 are monitored and controlled by the Dual ECU as described herein.

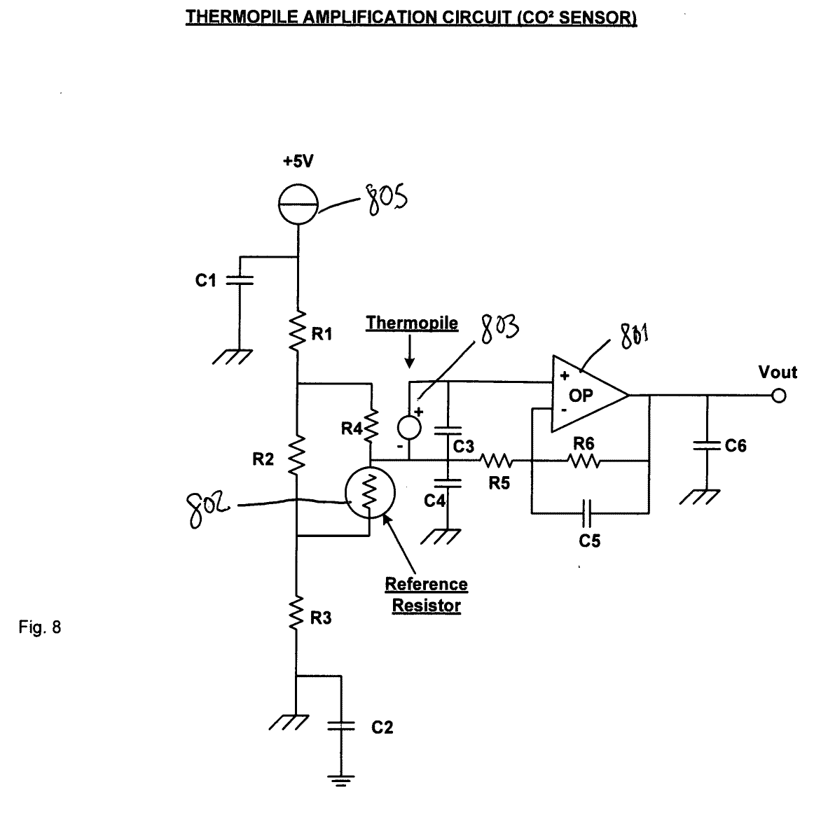

FIG. 8 is a typical schematic diagram of a circuit that might be coupled to the Thermopile Sensors depicted in FIG. 7 as more particularly described herein above. The circuitry comprises, an Op-Amp (801), a Reference Resistor (802), a Thermopile Transducer (803), and the necessary compliment of resistors and capacitors which are signified in the drawing by ‘R’ numbers for Resistors and ‘C’ numbers for Capacitors. The entire circuit is intended to be driven by a +5 volt D.C. source (804).

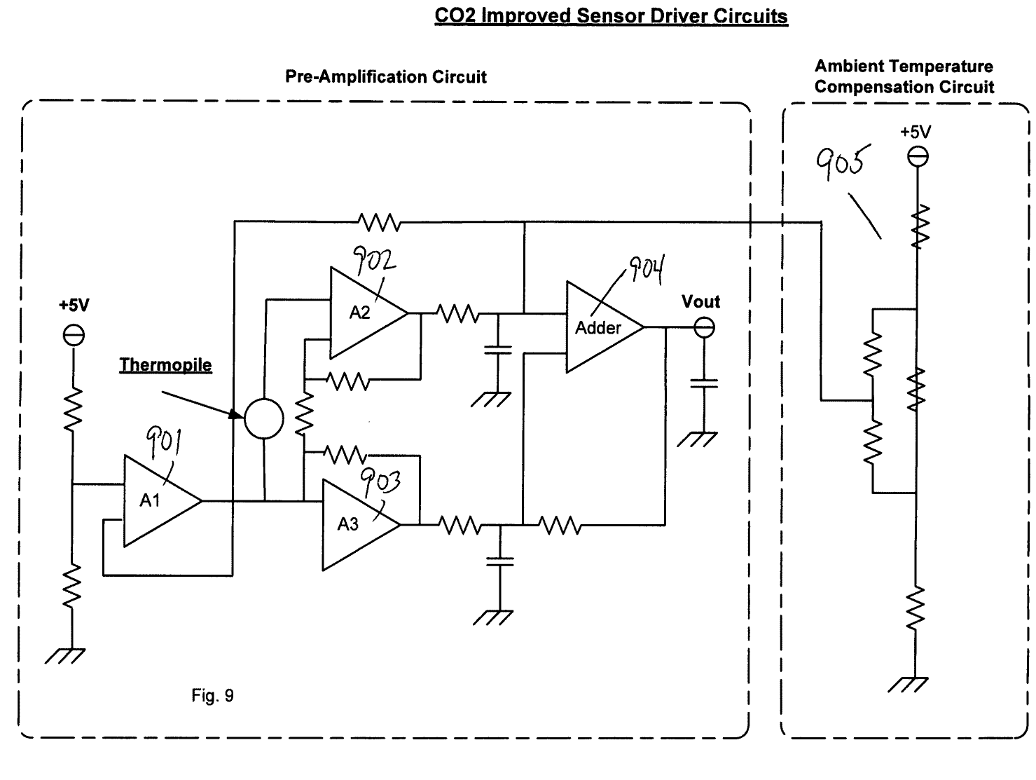

FIG. 9 is the schematic circuit diagram of an improved Thermopile Driver Circuit, which comprises three Op-Amps (901), (902), and (903). The Thermopile Transducer or Sensor (904) is connected between Op-Amps (902) and (903) which averages the readings through a fourth Op-Amp (904) which is temperature compensating as a result of circuit comprised in the outlined area (905), which allows for changes in Ambient Air Temperatures and is controlled by the Dual ECU, described in FIG. 2 herein.

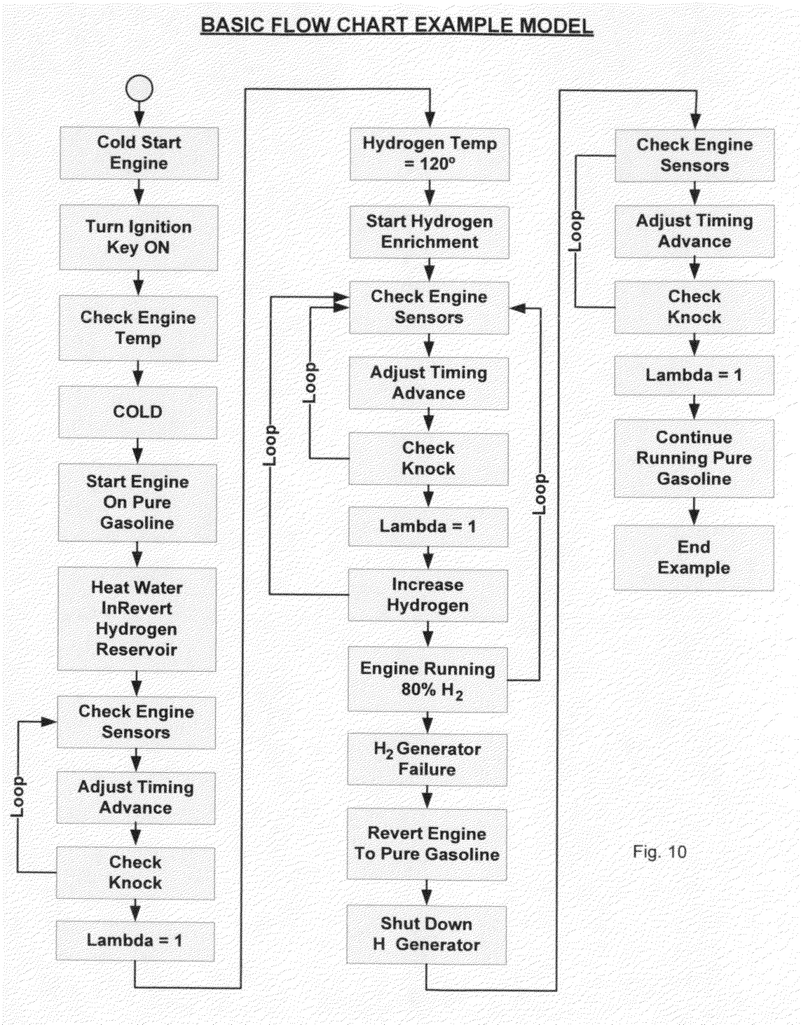

FIG. 10 is a simple flowchart which explains how the Dual ECU compensates for Cold Engine Starts, Hydrogen Temperature, Hydrogen Enrichment and Timing Advances to increase horse power and reduce emissions while burning H2 gases in a combustion or turbine engine. If the H2 Gas Generator Fails to Function, the Dual ECU converts the engine back to Fossil Fuels by adjusting the timing, mixtures and measuring the Lambda to prevent stalling or poor performance when converting back from H2.

I/We claim

1. a unique, customized, HHO Gas Generator comprising a Water Reservoir or Holding Tank containing an H2O+KOH solution, that is continuously re-circulated through and into a Hydrogen Generator containing Stainless Steel Plates that create electrolysis when a 12 volt D.C. voltage is applied, that in turn reacts with the H2O+KOH solution to generate HHO gases which are then vacuum pumped through a set of coils and the resulting HHO gas is then used to power a combustion engine or turbine engine.

2. The system so comprised in claim 1, that also includes a custom designed Dual ECU control unit that constantly monitors the system and adjusts to compensate for changes in atmospheric conditions such as: Humidity, Temperature, H2:O2 mixture ratios, Flow Rates of the Solution through the Generator, Flow Rates of Gas Output and a Digitally Controlled LCD Display readout.

3. The system so comprised in claim 2, that also includes a custom, improved CO2-O2 sensor which has a series of OP-Amps that compensate for Ambient Temperature Variations to control a Thermopile I/R Sensor as is manufactured by Perkin Elmer Corporation to control exhaust emission gases and polluting greenhouse gases.

4. The system described in claim 3, that also includes a custom Cooling Coil at the output of the HHO gas generator that super cools the H2 gases in order to compress the H2 molecules to create a fuel to Oxygen ratio of approaching 34:1, which creates greater fuel economy, increases power and torque and at the same time results in no pollutants being released into the atmosphere.

5. The system described in claim 1, wherein the Dual ECU controls the H2O+KOH water temperature, flow rate, and HHO gas output to adjust the fuel mixture, timing and lambda.

6. The system described in claim 1, wherein the H2O+KOH solution is combined with fossil fuels such as gasoline, kerosene, raw crude oil or heavy crude oil.

7. The system described in claim 1, wherein the output HHO gases are run through a series of bubbler tanks to extract hydrocarbons and other sludge.

8. The system described in claim 2, wherein in case that the HHO generator or its sensors or associated hardware should fail, the Dual ECU immediately reverts the timing, fuel mixture, lambda back to the original manufacturers engine specifications for regular fossil fuel operations.

9. The system described in claim 2, wherein the stoichiometric mixture automatically reverts back to 14.7:1 at such time as the altitude, outside air temperature, and humidity create an unstable or sluggish engine condition, until such time as the HHO mixture ratios can be moved back towards (ideally) those approaching 35:1, to compensate for the environmental changes.

10. The system described in claim 3, wherein the Exhaust Gas Temperature indicator approaches in excess of 1000 degrees Fahrenheit and the Dual ECU reduces the amount of fossil fuel being introduced into a diesel engine to the bare minimal.

11. The system described in claim 2, as may be applied to its use in hobby craft, such as scaled down turbine powered radio controlled airplanes, boats and miniature racing cars.

12. The system as described in claim 2, wherein the HHO gases may be used to generate fuel for a steam powered or turbine powered home or residential electrical power generator.
